(19) United States
(12) Patent Application Publication
(10) Pub. No.: US 2006/0197843 A1
(43) Pub. Date: Sep. 7, 2006

(54) Digital camera for correcting tilted image

(75) Inventor: Eiji Yoshimatsu, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/364,012

(22) Filed: Mar. 1, 2006

(30) Foreign Application Priority Data
Mar. 1, 2005 (JP) 2005-55517

(51) Int. Cl. H04N 5/225

(52) U.S. Cl. 348/219.1

(57) ABSTRACT

A digital camera includes a gyroscope for sensing an angle by which the image sensing surface of the camera is tilted relative to the horizontal direction. A system controller, when receiving the tilt angle from the gyroscope, adds the tilt angle to image data temporarily stored in an image memory, which is included in a signal processor, in the form of tag information. A correcting circuit rotates the image in the opposite direction by the tilt angle in accordance with the tag information added to image data and causes a monitor to display the resulting image. The digital camera thus produces the image to be displayed in its adequate position without resorting to any device for holding the camera in its adequate position.

### BACKGROUND OF THE INVENTION

1. Field of the Invention

The present invention relates to a digital camera for picking up an image of a subject field to reproduce or display the image picked up.

2. Description of the Background Art

A digital camera is sometimes required to be held in an adequate position when shooting a desired subject because, if the position of the camera is not adequate, the subject is displayed on its display monitor screen, which is usually rectangular, in a tilted position with respect to the frame of the screen. The tilt of a captured subject image displayed on the monitor screen is caused when the camera is positioned with its reference direction, such as either one of the edges of the imaging frame formed by its photosensitive array, or image sensing surface, is not coincident with the actual horizontal direction in the field including the intended subject. In light of this, it has been customary to provide a digital camera with a leveling function or mount the camera to a tripod in a horizontal position.

Japanese patent laid-open publication No. 2004-145232, for example, discloses a device for holding a camera, video camera or similar image pickup apparatus. With the holding device taught in this document, a person, operating the camera, hangs a strap from, e.g., the top of trousers, a belt or the neck and inserts hook portions formed at the lower end of the holding device into the strap. In this condition, the person holds the camera by using the hook portions as a fulcrum, so that a stable image is achievable even during walking.

However, the problem with the holding device stated above is that the operator of the camera has to insert the hook portions formed at the lower end of the holding portion into the strap by troublesome operation. Moreover, it is awkward for the operator to use such a holding device simply in order to shoot a desired subject with the horizontal position maintained.

### SUMMARY OF THE INVENTION

It is an object of the present invention to provide a digital camera for producing a subject image to be displayed in its adequate position without resorting to any special holding device.

A digital camera of the present invention includes an image sensor for picking up an image and having an image sensing surface on which a plurality of photoelectric transducers are arranged. An angle sensor senses an angle by which the image sensing surface is rotated from a reference position in a first direction about an optical axis perpendicular to the image sensing surface. An image correcting circuit rotates a digital image picked up by the image sensor in a second direction opposite to the first direction by the angle sensed by the angle sensor to produce a corrected digital image.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of a digital camera in accordance with the present invention;

FIG. 2A shows a specific image picked up by the camera of FIG. 1 held in a tilted position;

FIG. 2B conceptually shows the outline structure of the camera in accordance with the illustrative embodiment shown in FIG. 1;

FIG. 3A shows a specific image picked up;

FIG. 3B corresponds to FIG. 3A, but shows an image corrected by rotation unique to the illustrative embodiment;

FIG. 4A shows the image corrected by rotation;

FIG. 4B shows an image produced by enlarging the image shown in FIG. 4A;

FIG. 5A shows the image corrected by rotation;

FIG. 5B shows an image produced by reducing the image shown in FIG. 5A; and

FIG. 6 schematically shows a roll axis, a pitch axis and a yaw axis about which the digital camera may be inadvertently rotated.

### DESCRIPTION OF THE PREFERRED EMBODIMENT

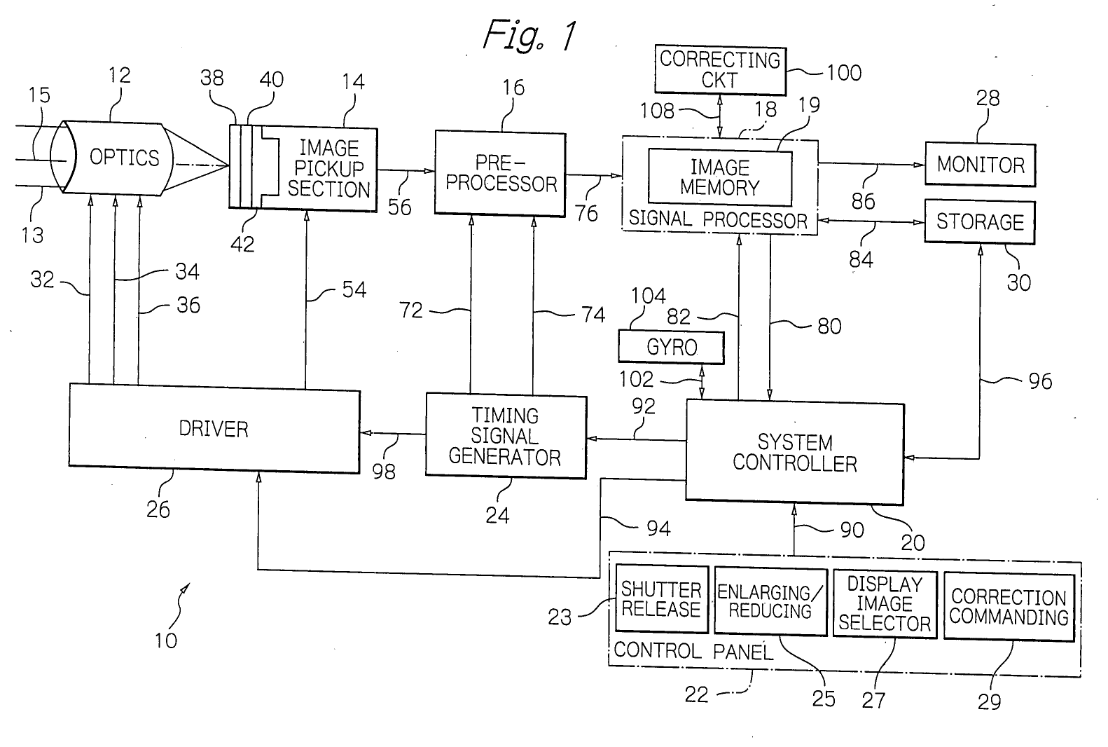

Referring to FIG. 1 of the accompanying drawings, a digital camera embodying the present invention, generally 10, includes an optics 12, an image pickup section 14, a preprocessor 16, a signal processor 18, a system controller 20, a control panel 22, a timing signal generator 24, a driver 26, a video monitor or display 28, a storage 30, an image correcting circuit 100 and a gyroscope or angle sensor 104, which are interconnected as illustrated. It is to be noted that part of the illustrative embodiment not directly relevant to the understanding of the present invention is not shown, and detailed description thereof will not be made in order to avoid redundancy. The optics 12 includes a mechanical shutter, a lens system, a zoom mechanism, an iris control mechanism and an automatic focus (AF) control mechanism, although not shown specifically. The optics 12 is configured to conduct light 13 incident from an imaging field through the lens system to the image pickup section 14 with its various mechanisms mentioned above controlled.

The zoom mechanism controls the angle of field while the automatic focus mechanism drives a plurality of optical lenses to focus a desired object. Motors, drivably connected to such mechanisms, are driven by drive signals 32 output from the driver 26.

The iris control mechanism, having an automatic exposure (AE) control function, includes a ring portion configured to rotate in response to the drive signal 34 for varying the aperture of its iris diagraph, although not shown specifically. The mechanical shutter of the iris control mechanism may alternatively be included in the lens system as a lens shutter, if desired.

The mechanical shutter prevents light from being incident on the image pickup section 14 except the time of a shot, i.e., selectively opens or closes the shutter in response to the drive signal 36 fed from the driver 26, thereby determining an exposure period of time.

The image pickup section 14 includes an image sensor or image sensing device 42 that includes an optical low-pass filter 38 and a color filter 40. The optical low-pass filter 38 filters out the spatial frequency components of the incident light 13 above the Nyquist frequency. The color filter 40 has its color filter segments positioned in one-to-one correspondence to photosensitive cells or photoelectric transducers, which are arranged on the image sensor 42 to form an array, at the light incidence side of the image sensor 42. The color filter 40 separates the color components of the incident light 13 in accordance with the spectral characteristic of the individual color filter segments.

The solid-state image sensor or photoelectric converting device 42 has an array of photosensitive cells or photoelectric transducers which are bidimensionally arranged on its image sensing surface, as a plane substantially perpendicular to the optical axis 15 of, the optics 12, in the horizontal and vertical directions in order to convert light 13 incident thereto to corresponding electric signals. In the description, signals are designated by reference numerals attached to signal lines on which they appear. As shown in FIG. 1, to the image pickup section 14, drive signals 54 are fed from the driver 26. Then drive signals 54 include a horizontal and a vertical drive signal, an overflow drain (OFD) control signal and so forth. The image pickup section 14 delivers an analog voltage signal 56 output from the image sensor 42 to the preprocessor 16.

The preprocessor 16 includes a correlated-double sampling (CDS) circuit for canceling noise, again-controlled amplifier (GCA) and an analog-to-digital (A/D) converter, although not shown specifically. The CDS circuit is fed from the timing signal generator 24 with CDS pulses 72 in the form of sampling signal. The A/D converter is fed with a conversion clock signal 74. The preprocessor 16 executes noise cancellation, wave shaping and digitization and delivers all data resultant from the processing to the signal processor 18 in the form of digital data, or image data, 76.

The signal processor 18 includes an image memory 19 and executes various image signal processing functions including gamma-correction, synchronization, image conversion, compressing/expanding, input/output interfacing, image display processing and image enlarging/reducing.

The image memory 19 of the signal processor 18 is generally supplied with the digital image data 76 over a data bus 76 as an image signal. The operation of the signal processor 18 is controlled by a control signal 82 fed from the system controller 20 over a control bus 82. The signal processor 18 is fed with timing signals, not shown, from the timing signal generator 24. The timing signals include a horizontal and a vertical synchronous signal.

The various functions of the signal processor 18 mentioned earlier will be briefly described hereinafter. The gamma correction function performs gamma correction on the image data fed from the image memory 19 by use of data listed in a lookup table which the signal processor contains.

The synchronization function executes interpolation on a pixel of interest with colors not available with either one of the actual and virtual pixels taken into account, thereby producing all of the three primary colors at each pixel. Interpolation may be effected by, e.g., multiplying the individual pixels by weighting coefficients on the basis of a correlation between the pixel data, adding the resulting products, and then producing a mean value of the resulting sum. In this manner, three primary colors can be produced for a pixel of interest at the same time. The term “synchronization” is used in this sense. The image data thus synchronized are written into the image memory 19.

The image converting function multiplies the synchronized image data of three primary colors by a preselected coefficient for thereby executing color-difference matrix processing.

The compressing/expanding function compresses image data and color difference data fed thereto in a photo mode or a movie mode by using the JPEG (Joint Photographic coding Experts Group) standard, MPEG (Moving Picture coding Experts Group)-1 or MPEG-2 standard or similar standard. The input/output interfacing function adjusts electric conditions and timing of the signals or data in the event of writing or reading image data in or out of a card type recording medium loaded on the storage 30. Image data 84 thus processed by the input/output interface function are written into the storage 30. Further, the compressing/expanding function reads out image data 84 from the storage 30 and then expands the image data 84 subjected to input/output interface processing. It is to be noted that expansion is opposite to compression in the same processing procedure or standard.

The image displaying function converts the image data generated or image data (and color-difference data) expanded in the event of reproduction to R (red), G (green) and B (blue) components of image data and then formats the image data in a number of pixels that can be displayed on the screen of the monitor 28. Image data 86 thus formatted are input to the monitor 28. The number of pixels to be displayed, or the size of the monitor screen, is so selected as to protect an image from defects ascribable to pixel skipping or thinning out that would otherwise be caused.

The image memory 19 of the signal processor 18 receives the digital data, i.e., image data 76 and temporarily stores the data therein. Further, in the various kinds of processing stated above, image data thus temporarily stored in the image memory 19 are read out from the image memory 19 and again written into the memory 19 after processed. In an application where the same image data are expected to be repeatedly read out from the image memory 19, the image memory 19 may preferably be implemented by a nonvolatile memory device.

The system controller 20 is implemented by a microcomputer or a CPU (Central Processing Unit) adapted to overall control the common portions and digital processing portions of the camera 10. The system controller 20 includes a ROM (Read Only Memory) storing a program sequence of operation instructions. Further, the system controller 20 controls the timing signal generator 24 and driver 26.

The system controller 20 receives a command signal 90 representative of a mode selected or an operational trigger entered through the control panel 22, and generates a control signal 92 in accordance with the content of the command signal 90 to feed it to the timing signal generator 24.

The system controller 20 takes account of line interpolation to be executed by the signal processor 18, and control over a signal generator and signal processing to also produce a control signal 82. Further, the system controller 20 also outputs a control signal 96 for writing and reading of image data to and from the storage 30 as well. In addition, the system controller 20 controls the operation timing of the preprocessor 16, although not shown specifically.

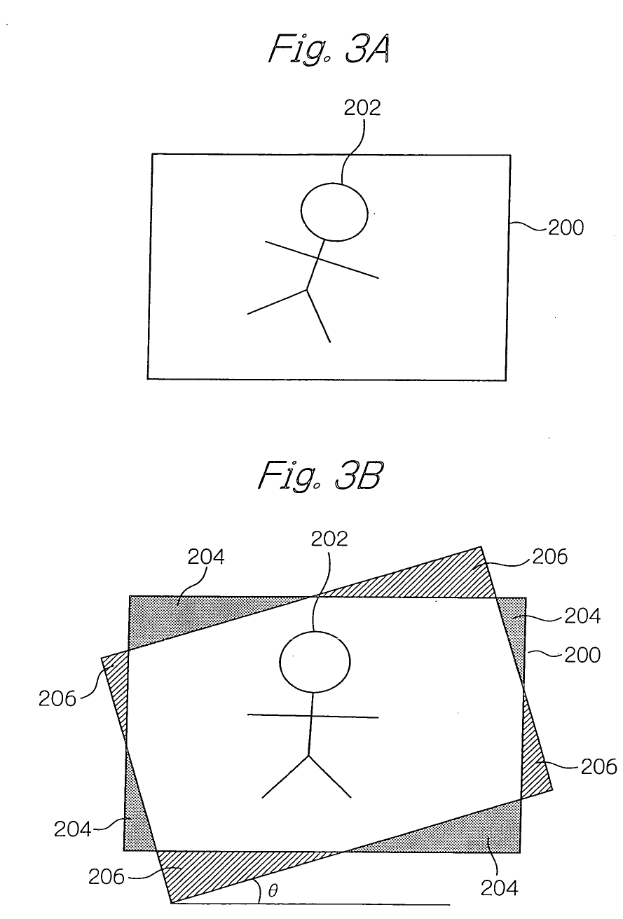

The control panel 22 includes a shutter release button 23, an enlarging/reducing key 25 for instructing enlargement and reduction of a display image, a display image selector 27 for selecting and deciding a display image device, and a correction commanding key 29 for commanding image correction. The control panel 22 is responsive to the states of the shutter release button 23 and keys 25 through 29 to feed a command signal 90 to the system controller 20. The control panel 22 may additionally be provided with a zoom select key and direction keys, not shown, so that the operator of the camera 10 is allowed to use them to select desired one of the conditions displayed on the monitor 28. The monitor 28 is equipped with a display screen, not shown, having its reproduction frame 200, FIG. 3A, which will be described later, and is generally implemented by a liquid crystal display (LCD) panel. The role of the enlarging/reducing key 25 may be assigned to the direction keys. In such a case, an “up” key and a “down” key may be assigned to enlargement and reduction functions, respectively, so as to allow the operator to easily operate the control panel 22 as imagined.

The shutter release button 23 is implemented as a button having two stepwise strokes or positions, e.g., the first stroke or half-stroke position for conditioning the camera 10 for preliminary image pickup and the second stroke or full-stroke position for conditioning it for actual image pickup. The command signal 90 is representative of the trigger timing indicative of the first and second strokes also.

The correction commanding key 29 is adapted to indicate that image correction should be executed on image data by rotation, as will be described more specifically later. The display image selector 27 is a key for feeding, when manipulated, the system controller 20 with the command signal 90 that causes the signal processor 18 to sequentially reads image data 82 stored in the storage 30 one by one while displaying them on the monitor 28. The enlarging/reducing key 25 serves as instructing enlargement or reduction of an image being displayed on the monitor 28, as will also be described more specifically later.

The timing signal generator 24 is adapted to generate various timing signals from a reference or basic clock signal. The timing signal includes a horizontal transfer signal, a vertical synchronous signal, a horizontal synchronous signal, field shift pulses, a vertical transfer signal and an electronic shutter pulse. In addition, the timing signal generator 24 generates CDS pulses 72 and a conversion clock signal 74 to deliver them to the preprocessor 16. The timing signal generator 24 provides the driver 26 with the timing signals 98, including the vertical synchronous signal, horizontal synchronous signal, field shift pulses, vertical transfer signal and electronic shutter pulse.

The driver 26 includes a drive circuit for generating the drive signals 32 through 36 and 54 in response to the timing signal 98 and control signal 94. More specifically, the driver 26 feeds the drive signals 32, 34 and 36 to the lens system and iris control mechanism included in the optics 12 for causing them to effect automatic focus control and automatic exposure control. The driver 26 is operative in accordance with the timing of an actual shot defined by the manipulation on the shutter release button 23 of the control panel 22 to produce the drive signal 36, causing the mechanical shutter to open and then close.

The driver 26 also generates the drive signal 54 in response to the timing signal 98 to feed the signal 54 to the image sensor 42 of the image pickup section 14. The drive signal 54 functions as causing the image pickup section 14 to store signal charges in the photo-sensitive areas of the individual photosensitive cells or photoelectric transducers during an exposure period of time, and subsequently causing the signal charges to be read out to the vertical transfer paths and then transferred to the horizontal transfer path to output the signal charges from the horizontal transfer path in the form of an analog voltage signal 56 via an output amplifier.

The monitor 28 generally implemented by an LCD panel, as mentioned earlier, includes a display controller, not shown, which is adapted for visualizing the image data 86 fed from the image memory 18 to display an image represented by the data on its display screen. The LCD panel is equipped with an LCD controller, not shown, which is configured to controllably apply a voltage to the LCD panel so as to switch the orientation of liquid crystal molecules to thereby display an image. Of course, the LCD panel may be replaced with any other display unit so long as it is small in size and capable of saving power.

The storage 30 is loaded with a semiconductor memory or similar recording medium for storing therein the image data/tagged image data 84 and data of background colors fed from the signal processor 18. Tagged image data, as distinguished from the usual image data, and background colors will be described specifically later. The recording medium may, of course, be implemented by an optical disk or a magneto-optical disk instead of a semiconductor memory. The storage 30 selectively writes or reads the data in or out of the recording medium by using a pickup or transducer, or a combination of an optical pickup with a magnetic head matching the recording medium to use. Writing and reading the data to and from the storage 30 is executed by a control signal 96 fed from the system controller 20.

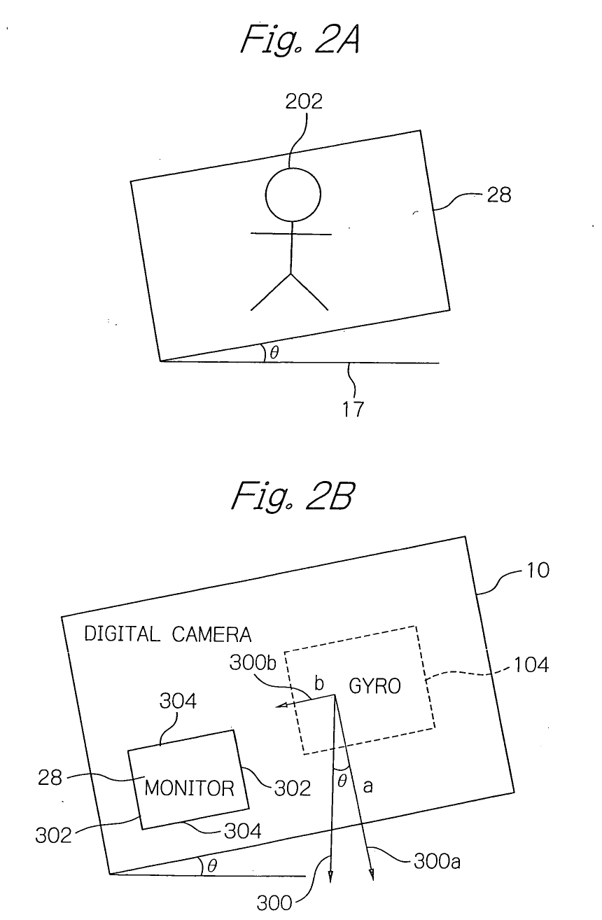

The illustrative embodiment is specifically characterized by the correcting circuit 100 and gyroscope 104 included in the digital camera 10. Reference will be made to FIGS. 2 trough 6 for describing the functions of the correcting circuit 100 and gyroscope 104 in detail.

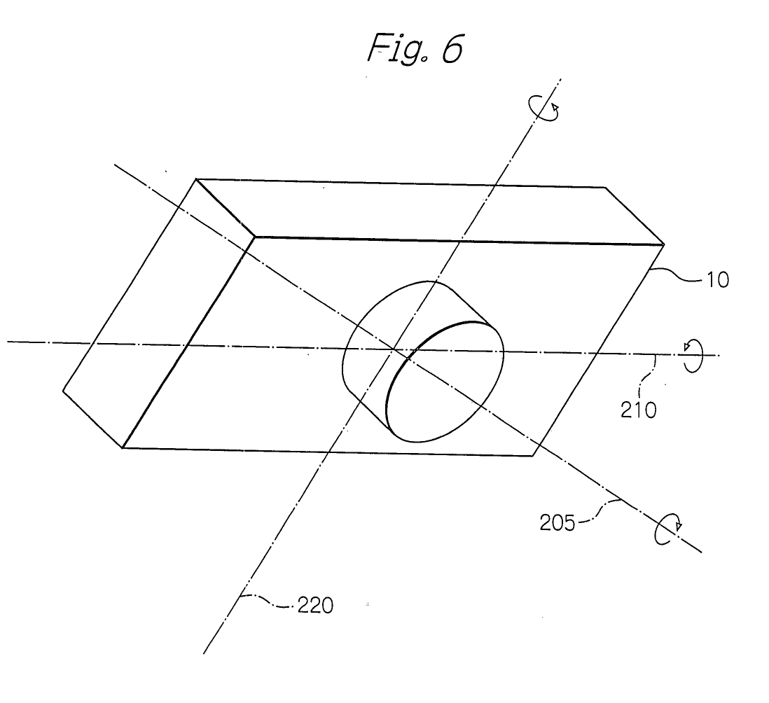

The gyroscope 104 has two different degrees of freedom in position. More specifically, as shown in FIG. 6, the camera 10 is provided with the gyroscope 104 such that, when the camera 10 is oriented with the image sensing surface, formed by the photosensitive array of the camera 10, substantially parallel to the vertical direction, the camera 10 has its optical axis 15, FIG. 1, substantially horizontal so that the gyroscope 104 has its roll axis 205 extending substantially in the direction of the optical axis 15, its horizontal pitch axis 210 substantially perpendicular to the roll axis 205 and its yaw axis 220 substantially vertical. In that orientation, the gyroscope 104 is capable of sensing tilt angles of the camera about the roll axis 205 and pitch axis 210. In the illustrative embodiment, the position of the camera 10 is determined by the tilt angles of the camera 10 about the two axes 205 and 210.

If desired, the gyroscope 104 with two degrees of freedom may be replaced with a gyroscope with a single degree of freedom because the present invention may sufficiently be implemented by correcting the tilt angle about the roll axis 205. Further, because the gyroscope 104 should only play the role of a sensor responsive to the tilt angle about the roll axis 205, it may be replaced even with an acceleration sensor, angle meter or similar inertia-based device.

The solid-state image sensor 42 included in the image pickup section 14, FIG. 1, has an array of photoelectric transducers or cells, which are bidimensionally arranged in the horizontal and vertical directions on its image sensing surface. As shown in FIG. 2B, let a vector 300a parallel to the image sensing surface, or the array of photosensitive cells, of the image sensor 32 and extending in parallel to the vertical transfer paths be referred to as a vertical-direction position vector, and let another vector 300b parallel to the image sensing surface and extending perpendicularly to the vertical transfer paths be referred to as a horizontal-direction position vector. The directions of the two vectors 300a and 300b vary in dependence upon the position of the camera 10, but are always perpendicular to each other.

Also conceptually shown in FIG. 2B is the rectangular monitor screen of the monitor 28 mounted on the camera 10 and having its short sides 302 and long sides 304. In FIG. 2B, assume that the vertical-direction position vector 300a and horizontal-direction position vector 300b are identical in direction with the short sides 302 and long sides 304, respectively.

While the gyroscope 104 is capable of sensing tilt angles of the camera 10 about both of the roll axis 205 and pitch axis 210, the illustrative embodiment pays attention simply to the tilt angle about the roll axis 205 as to the correction of an image. More specifically, the embodiment aims at correcting the rotation or tilt of the camera 10 occurring about its own optical axis. Stated another way, when the camera 10 is tilted upward or downward about the pitch axis 210 for shooting a desired subject, the camera 10 of the embodiment does not correct such an image.

As shown in FIG. 2A, when the camera 10 is tilted about the roll axis 205 at the time of shooting a desired object, an image viewed on the screen of the monitor 28 is tilted accordingly. The embodiment corrects such a tilted image by rotating it. More specifically, the camera 10 of the embodiment is adapted to rotate the image of FIG. 2A tilted counterclockwise in the clockwise direction about the roll axis 205 by an angle of θ with respect to a reference, e.g., horizontal, direction 17. The resulting corrected image is identical with an image which would have been picked up if the camera 10 were held in its adequate position, i.e., if the camera 10, actually tilted, were operated with the image sensing surface of the image sensor 40 rotated about the optical axis perpendicularly thereto in order to position either the vertical-direction position vector 300a, FIG. 2B, or the horizontal-direction position vector 300b, FIG. 2B, horizontal.

In the illustrative embodiment, the tilt angle θ is selected to be 45 degrees or less. More specifically, one of the vertical-direction and horizontal-direction position vectors 300a and 300b, which is smaller in rotation angle up to the horizontal when the camera 10 is rotated in the image sensing surface formed by the photosensitive array is assumed to be the tilt angle θ. This is because the camera 10 is selectively held either horizontally or vertically long in dependence on the field selectively snipped by a horizontally long or a vertically long range. Thus, an image is corrected such that the horizontal-direction position vector 300b becomes directed horizontally when the camera 10 is held horizontally long, or the vertical-direction position vector 300a becomes directed horizontally when the camera 10 is held vertically long.

FIG. 2B schematically shows the rotation angle θ in a specific condition where in the camera 10 shot a subject in a position tilted about the roll axis 205. In this case, a vertical-direction vector 300 can be divided in component into the vertical-direction and horizontal-direction position vectors 300a and 300b. Assuming that the two vectors 300a and 300b have lengths of a and b, respectively, then the rotation or tilt angle θ may be expressed as b/a=tan θ.

The system controller 20 serves as receiving a trigger timing signal 90 sent from the control panel 22 in response to the shutter release button 23 on the control panel 22 depressed by the second stroke, i.e., to its full-stroke position for an actual shot, to take in data representing an angle θ sensed by the gyroscope 104 over a signal line 102 and then send the data to the signal processor 18 in the form of signal 82.

The signal processor 18 has the function of receiving the signal 82 from the system controller 20 to add the angle θ to the image data as tag information and then deliver the resulting tagged image data 84 to the storage 30. The signal processor 18 is capable of reading the tagged image data 84 thus stored in the storage 30 and sending them to the correcting circuit 100.

The correcting circuit 100 is adapted for receiving the tagged image data 84 over a line 108, and detecting the angle θ represented by tag information contained in the tagged image data. If a subject 202 represented by the image data is detected to be tilted, as shown in FIG. 3A by way of example, then the correcting section 100 rotates the image or picture of the data counterclockwise by the angle θ about the center of the pickup range by an arithmetic operation, thereby correcting the image data as if the image were picked up by the camera 10 substantially accurately held in the horizontal or the vertical position, as shown in FIG. 3B. The correcting circuit 100 then returns the corrected image data to the signal processor 18 over the signal line 108. In regions 204, image data to be reproduced are absent while, in regions 206, image data to be reproduced are present, but not contained in the reproduction frame 200.

The camera 10 may be adapted, if desired, such that the center of the rotation of an image of the data may be on any desired point in a frame of image selected on the control panel 22 by the operator of the camera 10. The correcting section 100, implemented as an independent circuit, may alternatively be included in the signal processor 18.

The signal processor 18 functions as filling the regions 204, FIG. 3B, where image data to be displayed after correction are absent with one of the background colors stored in the storage 30. The signal processor 18 may be adapted to automatically select as a background color a color which is identical with majority one of the colors represented by the pixels reproduced or contained around, or in the vicinity of, the regions 204, e.g., the edges of the image. Alternatively, the camera 10 may be adapted such that the operator of the camera 10 use the display image selector 27 of the operation panel 22 to reproduce the background colors and any desired image stored in the storage 30 and then select and set one of the background colors adequate for the image. The background color thus selected by the operator is reproduced or visualized in the regions 204.

The signal processor 18 is capable of enlarging or reducing the image data instead of filling up the empty regions 204 within the reproduction frame 200, FIG. 3B, with a background color. More specifically, the signal processor 18 enlarges an image in order to exclude the empty regions 204, or reduces an image in order to reproduce or include regions 206 lost due to the rotation of the image data in the reproduction frame 200.

While the enlargement and reduction of an image of the data may be executed by any conventional method, image data appearing on the monitor 28 or image data selected from image data stored in the storage 30 may be enlarged or reduced by a method disclosed in, e.g., Japanese patent laid-open publication No. 2004-288198 or 243218/1998. If desired, a plurality of different image data selected may be enlarged or reduced at the same time. The operator is capable of varying the magnification of enlargement or that of reduction by operating the image data enlarging/reducing key 25 of the operation panel 22.

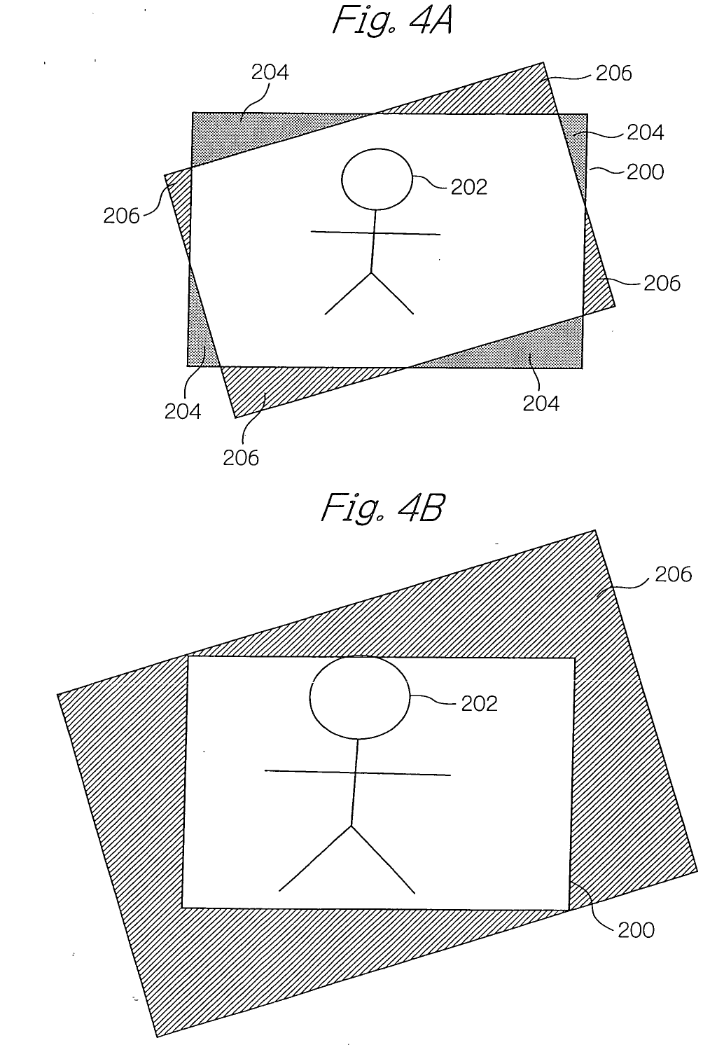

FIGS. 4A and 4B demonstrate how image data corrected by rotation are enlarged specifically. As shown in FIG. 4A, image data corrected by rotation are displayed as a visible image within the reproduction frame 200, but there exist the regions 204 where image data to be reproduced are absent and the regions 206 where image data are present, but not contained in the reproduction frame 200. In this case, the signal processor 18 may enlarge the image little by little until all the regions 204 disappear, as shown in FIG. 4B, and then reproduce the final image, in which case the image is reproduced within the entire reproduction frame 200.

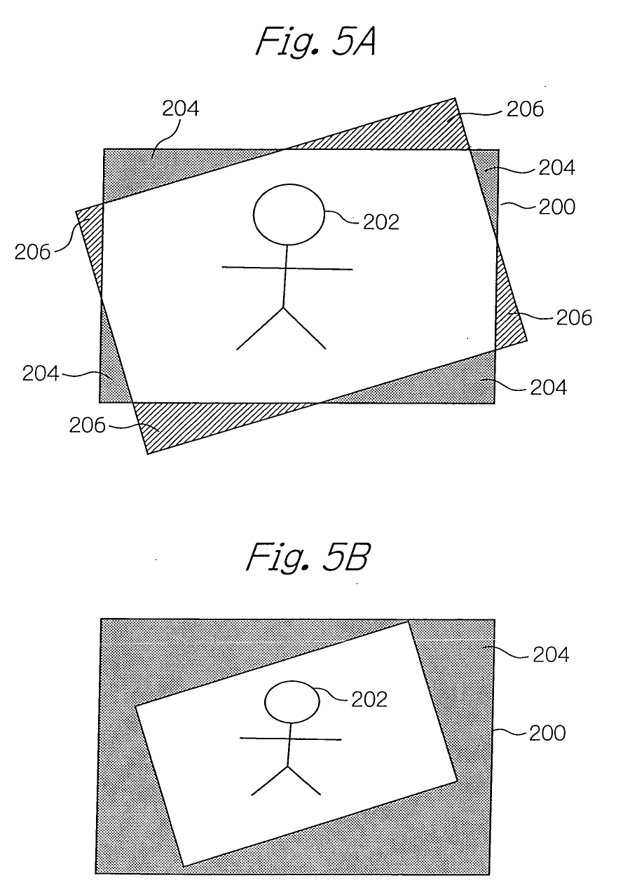

FIGS. 5A and 5B show how image data corrected by rotation are reduced specifically. FIG. 5A, like FIG. 4A, shows image data corrected by rotation and reproduced in the reproduction frame 200. When the image data shown in FIG. 5A should be reduced, the signal processor 18 may reduce them little by little until the regions 206, not lying in the reproduction frame 200, entirely lie in the reproduction frame 200, as shown in FIG. 5B, and then reproduce the image, in which case the entire image picked up is reproduced within the reproduction frame 200. At this instant, a desired background color may be reproduced or visualized in the regions 204.

An alternative method of enlarging or reducing an image of the data corrected by rotation will be described hereinafter. The alternative method begins with a step of determining the number of persons present or viewed in an image by use of a face image separating procedure taught in Japanese patent laid-open publication No. 2000-295574. If the number of persons is equal to or smaller than a predetermined number, then the signal processor 18 enlarges the image with a magnification that causes the regions 204 to be excluded from the reproduction frame 200, as shown in FIG. 4B. Conversely, if the number of persons is greater than the predetermined number, then the signal processor 18 reduces the image data with a magnification that causes even the regions 206 to be reproduced or included within the reproduction frame 200, as shown in FIG. 5B. In the event of reduction, the regions 204 may be filled with a desired background color.

A specific operation of the digital camera 10 having the above construction will be described hereinafter. As shown in FIGS. 2A and 2B, assume that the operator inadvertently holds the camera 10 in a position tilted by the angle θ when shooting a desired subject 202. Then, when a pickup timing is reported from the shutter release button 23 to the system controller 20, the system controller 20 sends a control signal 92 to the timing signal generator 24 and a control signal 102 to the gyroscope 104 at the same time. In response to the control signal 102, the gyroscope 104 senses the tilt angle θ. The system controller 20 reads the tilt angle θ thus sensed by the gyroscope 104 over the signal line 102 and then feeds data of the tilt angle θ to the signal processor 18 as a signal 82.

On receiving the control signal 92, the timing signal generator 24 generates a timing signal 98 and feeds it to the driver 26. In response, the driver 26 generates drive signals 32, 34, 36 and 54 based on the timing signal 98. The driver 26 delivers the drive signals 32, 34 and 36 to the optical lens system and iris control mechanism of the optics 12 in response to the control signal 94, causing them to execute automatic focus and exposure control. Further, the driver 26 sends the drive signal 36 to the mechanical shutter for causing it to open and close. In addition, the driver 26 generates the drive signal 54 in response to the timing signal 98 and sends the drive signal 54 to the image sensor 42 included in the image pickup section 14. The image sensor 42 produces an analog, imagewise voltage signal 56 in response to the drive signal 54.

The preprocessor 16 executes noise cancellation, wave shaping and digitization on the analog voltage signal 56 by using CDS pulses 72 and a conversion clock signal 74, which are fed from the timing signal generator 24. The preprocessor 16 then sends all the processed image data to the signal processor 18 as digital image data 76.

The signal processor 18 temporarily writes the digital data 76 in the image memory 19 thereof and then executes gamma conversion, synchronization, image conversion, compression or expansion, input interface processing and image display processing on the digital data 76 in response to the control signal 82. As a result, the digital data 76 are converted to image data 84. Further, when the control signal 82 input to the signal processor 18 includes the data of the tilt angle θ, the signal processor 18 adds the data of the angle θ to the image data as tag information and then writes the resulting tagged image data 84 in the storage 30.

The operator of the camera 10 is capable of operating the image selector 27 to watch a plurality of tagged images stored in the storage 30 on the monitor 28 one by one. The operator may then use the correction commanding key 29 in order to correct a desired image viewed on the monitor 28. When a command indicative of the correction of image data by rotation is output from the correction commanding key 29, the control panel 22 generates a command signal 90 and sends it to the system controller 20. In response, the system controller 20 sends a control signal 82 to the signal processor 18.

The signal processor 18, having received the control signal 82, sends the tagged image data representative of an image being reproduced to the correcting circuit 100. In response, the correcting circuit 100 detects the tilt angle θ out of the tagged image data and then rotates the image of the tagged image data about the center of the image by the angle θ in the opposite direction, which is opposite to the direction in which the tilt angle 0 is formed with respect to the reference direction 17. As a result the image data are corrected as if they were picked up by the camera 10 substantially accurately held in the horizontal or the vertical position. For example, the tilted image shown in FIG. 3A is rotated by the angle θ indicated by the tag information in the opposite direction, so that the corrected image shown in FIG. 3B is obtained. The data of the image thus corrected by rotation are transferred or returned from the correcting circuit 100 to the signal processor 18 and then displayed oh the monitor 28. At this instant, the regions 206 of the image not lying in the reproduction frame 100 are not displayed.

The signal processor 18 fills the regions 204, FIG. 3B, where image data to be displayed after corrected are absent with one of the background colors stored in the storage 30. At this instant, the signal processor 18 automatically selects a background color identical with a color represented by most of the pixels reproduced around, or in the immediate neighborhood of, the regions 204.

When the image data should be enlarged or reduced, a command signal 90 indicative of enlargement or reduction of the image of the data corrected or not corrected is sent from the enlarging/reducing key 25 of the control panel 22 to the system controller 20. In response, the system controller 20 sends a control signal 82 to the signal processor 18 so as to cause the latter to enlarge or reduce the image data to be viewed on the monitor 28 and again feeds them to the monitor 28.

More specifically, in the case of enlargement, image data corrected by rotation, as shown in FIG. 4A are displayed in the reproduction frame 200, but there exist the regions 204 where image data to be reproduced are absent and the regions 206 where image data are present, but not contained in the reproduction frame 200. In this case, the signal processor 18 may enlarge the image little by little until all the regions 204 disappear from the frame 200, as shown in FIG. 4B, and then reproduce the resultant image, in which case the image is reproduced in, or occupies, the entire reproduction frame 200.

On the other hand, in the case of reduction, image data corrected by rotation are reproduced in the reproduction frame 200, as shown in FIG. 5A. When the image of the data shown in FIG. 5A should be reduced, the signal processor 18 may reduce the image little by little until the regions 206, not lying in the reproduction frame 200, entirely lie within the reproduction frame 200, as shown in FIG. 5B, and then reproduce the resultant image, in which case the entire image picked up is reproduced within the reproduction frame 200. At this instant, a desired background color may be reproduced in the regions 204.

The signal processor 18 delivers the image data corrected by rotation, or enlarged or reduced, to the storage 30 over the signal line 84.

In summary, it will be seen that the present invention provides a digital camera capable of correcting an image after a shot for thereby reproducing and displaying an adequate image. It is therefore not necessary for the operator of the digital camera to care about the position of the camera at the time of shooting. Thus, the present invention is clearly distinguishable from conventional technologies that correct the position of a camera by use of a holder or similar exclusive apparatus before shooting.

The entire disclosure of Japanese patent application No. 2005-055517 filed on Mar. 1, 2005, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A digital camera comprising:
an image sensor for picking up an image, said image sensor comprising an image sensing surface on which a plurality of photoelectric transducers are arranged;
an angle sensor for sensing an angle by which the image sensing surface is rotated from a reference position in a first direction about an optical axis perpendicular to the image sensing surface; and
an image correcting circuit for rotating the image picked up by said image sensor in a second direction opposite to the first direction by the angle sensed by said angle sensor to produce a corrected digital image.

2. The digital camera in accordance with claim 1, wherein said image correcting circuit rotates the digital image about a center of the digital image.

3. The digital camera in accordance with claim 1, wherein said image correcting circuit rotates the digital image about a desired point of the digital image in the second direction.

4. The digital camera in accordance with claim 1, further comprising:
a display including a display screen having a reproduction frame for displaying the digital image on the screen; and
a background inserting circuit for displaying a background color in a region within the reproduction frame where an image to be displayed is absent.

5. The digital camera in accordance with claim 4, wherein said background inserting circuit selects the background color from a color represented by pixels reproduced around the region where an image to be displayed is absent.

6. The digital camera in accordance with claim 2, further comprising:
a display including a display screen having a reproduction frame for displaying the digital image on the screen; and
a background inserting circuit for displaying a background color in a region within the reproduction frame where an image to be displayed is absent.

7. The digital camera in accordance with claim 3, further comprising:
a display including a display screen having a reproduction frame for displaying the digital image on the screen; and
a background inserting circuit for displaying a background color in a region within the reproduction frame where an image to be displayed is absent.

8. The digital camera in accordance with claim 1, further comprising:
a display including a display screen having a reproduction frame for displaying the digital image on the screen; and
an image enlarging circuit for enlarging the corrected digital image to a degree that causes a region of the reproduction frame where an image would be lost if the corrected digital image were displayed to disappear, and causing said display to display a resulting enlarged digital image.

9. The digital camera in accordance with claim 2, further comprising:
a display including a display screen having a reproduction frame for displaying the digital image on the screen; and
an image enlarging circuit for enlarging the corrected digital image to a degree that causes a region of the reproduction frame where an image would be lost if the corrected digital image were displayed to disappear, and causing said display to display a resulting enlarged digital image.

10. The digital camera in accordance with claim 3, further comprising:
a display including a display screen having a reproduction frame for displaying the digital image on the screen; and
an image enlarging circuit for enlarging the corrected digital image to a degree that causes a region of the reproduction frame where an image would be lost if the corrected digital image were displayed to disappear, and causing said display to display a resulting enlarged digital image.

11. The digital camera in accordance with claim 1, further comprising:
a display including a display screen having a reproduction frame for displaying the digital image on the screen; and
an image reducing circuit for reducing the corrected digital image to a degree that causes a region of the reproduction frame which would bulge out from the reproduction frame if the corrected digital image were displayed to enter the reproduction frame, and causing said display to display a resulting reduced digital image.

12. The digital camera in accordance with claim 2, further comprising:
a display including a display screen having a reproduction frame for displaying the digital image on the screen; and
an image reducing circuit for reducing the corrected digital image to a degree that causes a region of the reproduction frame which would bulge out from the reproduction frame if the corrected digital image were displayed to enter the reproduction frame, and causing said display to display a resulting reduced digital image.

13. The digital camera in accordance with claim 3, further comprising:
a display including a display screen having a reproduction frame for displaying the digital image on the screen; and
an image reducing circuit for reducing the corrected digital image to a degree that causes a region of the reproduction frame which would bulge out from the reproduction frame if the corrected digital image were displayed to enter the reproduction frame, and causing said display to display a resulting reduced digital image.
